(19) United States
(12) Patent Application Publication
(10) Pub. No.: US 2025/0225893 A1
(43) Pub. Date: Jul. 10, 2025

(54) EXHIBITION BOX

(71) Applicant: CHUNG-HAO HSU, Taipei City (TW)

(72) Inventor: CHUNG-HAO HSU, Taipei City (TW)

(21) Appl. No.: 18/819,521

(22) Filed: Aug. 29, 2024

(30) Foreign Application Priority Data
Jan. 8, 2024 (TW) 113100758

(51) Int. Cl. G09F 5/00; G09F 9/30; G09G 5/00; G09G 5/10

(52) U.S. Cl. CPC G09F 5/00; G09F 9/30; G09G 5/003; G09G 5/10; G09G 2354/00

(57) ABSTRACT

An exhibition box includes a body having an accommodation space therein and a through hole communicating with the accommodating space, a display panel disposed on the body and covering the through hole, a display controller electrically connected to the display panel and outputting an image information to the display panel for displaying, and a light source disposed inside the body and being controllable to turn on and off. When the light source is on, a light of the light source penetrates from a first side to a second side; a displayed information on the display panel and the exhibit disposed in the accommodation space are observable from an outside. When the light source is off, an ambient light from an external environment is unable to penetrate from the second side to the first side; the displayed information and the exhibit are not observable from the outside.

### BACKGROUND OF THE INVENTION

### Technical Field

The present invention relates generally to a box body, and more particularly to an exhibition box.

### Description of Related Art

In recent years, commercial advertising has become an essential component of marketing products. A good marketing strategy could attract customers to purchase the products. Therefore, an exhibition box is widely applied to display the products. Through the exhibition box, the customers are attracted to view the products, thereby increasing the notability of the products and the sales revenue.

However, a conventional exhibition box typically involves placing the products inside a box body and utilizing various decoration or collage techniques to make the displayed products more notable. Furthermore, the products displayed inside the conventional exhibition box could be replaced only after business hours and could not be replaced at any time during business hours.

In this sense, the conventional exhibition box not only has the higher design cost and the higher time cost in decorating a single product, but also faces limitations in the time for replacing the displayed product.

Therefore, how to reduce the design cost of displaying the product in the exhibition box and enable changing the displayed product at any time without being limited by the business hours, is a problem needed to be solved in the industry.

### BRIEF SUMMARY OF THE INVENTION

In view of the above, the primary objective of the present invention is to provide an exhibition box, wherein a display on a display panel of the exhibition box could serve as an introduction of an exhibit and a decoration, and the exhibit could be replaced at any time.

The present invention provides an exhibition box includes a body, a display panel, a display controller and a light source, wherein an inner portion of the body has an accommodation space for placing an exhibit; the body has a through hole communicating with the accommodation space. The display panel is disposed on the body and covers the through hole, wherein the display panel has a first side and a second side; the first side faces toward the accommodation space; the second side faces away from the accommodation space; a light transmittance of the display panel in a direction from the first side to the second side is greater than a light transmittance of the display panel in a direction from the second side to the first side. The display controller is electrically connected to the display panel, and adapted to output an image information to the display panel for displaying. The light source is disposed inside the body, wherein the light source is controllable to turn on and turn off; when the light source is turned on, a light of the light source penetrates from the first side to the second side, so that a displayed information displayed on the display panel and the exhibit placed in the accommodation space are observable from an outside of the exhibition box; when the light source is turned off, an ambient light from an external environment is unable to penetrate from the second side to the first side, so that the displayed information displayed on the display panel and the exhibit disposed in the accommodation space are not observable from the outside of the exhibition box.

With the aforementioned design, the display controller could transmit the introduction of the exhibit and the decoration to the display panel for displaying, thereby decreasing the time and the expense in designing the introduction of the exhibit and the decoration when the exhibition box is applied. When the exhibit needs to be replaced, the light source could be directly turned off for replacing the exhibit without being seen by the customers and waiting for the end of the business hours to replace the exhibit. On the other hand, the exhibition box could instantly display the introduction of the replaced exhibit and the decoration.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the exhibition box according to a first embodiment of the present invention;

FIG. 2 is a sectional view along the X-X line in FIG. 1;

FIG. 3A is a schematic view, showing the light source inside the exhibition box is turned off;

FIG. 3B is a schematic view, showing the light source inside the exhibition box is turned on;

FIG. 4 is a schematic view, showing the data signal according to the first embodiment of the present invention is transmitted to the display controller through the external electronic device;

FIG. 5A is a schematic view, showing the display controller according to a second embodiment of the present invention displays the function icons on the display panel;

FIG. 5B is a schematic view, showing the display panel according to the second embodiment of the present invention displays the displayed content corresponding to the touch information; and

FIG. 6 is a schematic view, showing the exhibit according to a third embodiment of the present invention is charged while being displayed.

### DETAILED DESCRIPTION OF THE INVENTION

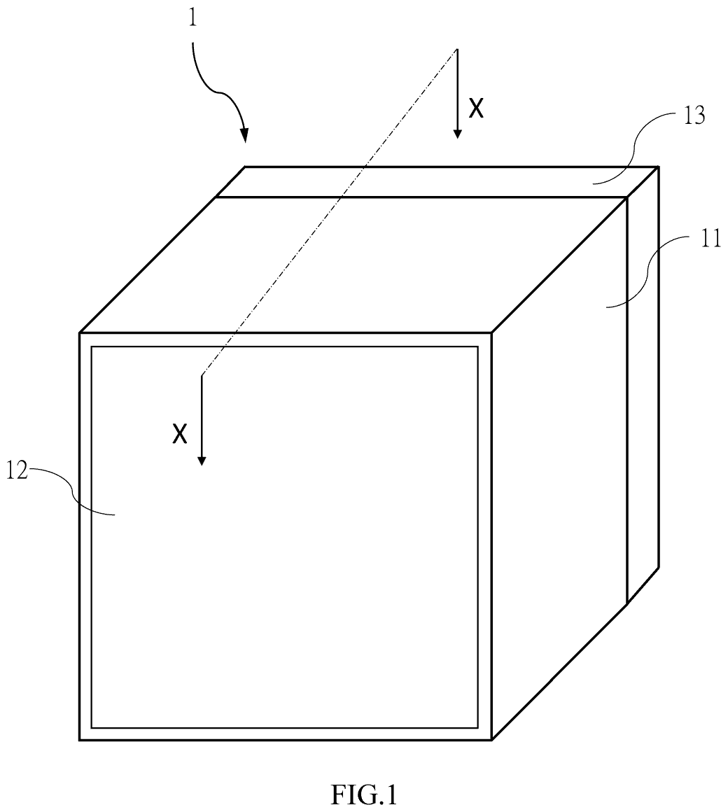

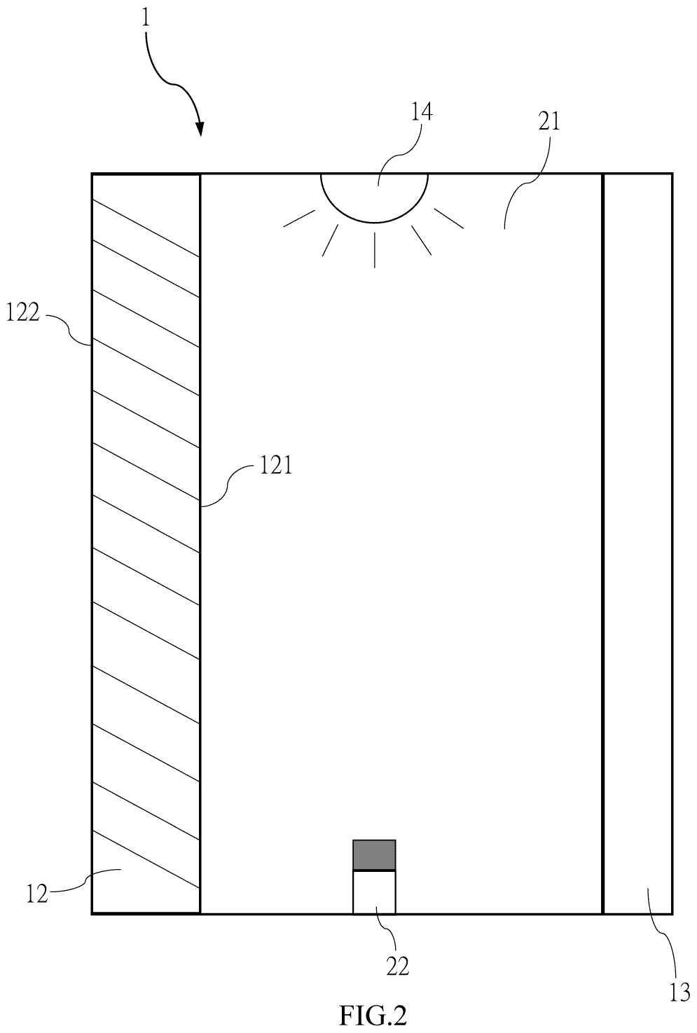

An exhibition box 1 according to a first embodiment of the present invention is illustrated in FIG. 1 to FIG. 3A and FIG. 3B and includes a body 11, a display panel 12, a display controller 13, and a light source 14. An inner portion of the body 11 has an accommodation space 21 for placing an exhibit 23. In the current embodiment, the exhibit 23 is shoes as an example, but not limited thereto. In addition, the body 11 has a through hole communicating with the accommodation space 21. A fixing device 22 is disposed on a bottom surface of the inner portion of the body 11; the fixing device 22 could be a claw, a screw, a magnet, a socket, a signal connector (such as a USB connector and a Lightning connector), etc. In the current embodiment, the fixing device 22 is a USB connector.

The display panel 12 is disposed on the body 11 and covers the through hole. The display panel 12 has a first side 121 and a second side 122, wherein the first side 121 faces toward the accommodation space 21, and the second side 122 faces away from the accommodation space 21 (i.e. towards an outside of the body 11). Additionally, a light transmittance of the display panel 12 in a direction from the first side 121 to the second side 122 is greater than a light transmittance of the display panel 12 in a direction from the second side 122 to the first side 121. The display panel 12 could be an LCD screen, an LED screen, an OLED screen, or a touchscreen screen that is provided without a backlight module.

The display controller 13 is electrically connected to the display panel 12 and is adapted to output an image information to the display panel 12 for displaying. For example, a user could transmit an electronic information, which includes an introduction of the exhibit 23 or a decorative image designed in advance, to the display controller 13, and the introduction of the exhibit 23 or the decorative image is transmitted to the display panel 12 through the display controller 13 for displaying, thereby attracting customers to watch the exhibit 23 and learn the related information of the exhibit 23.

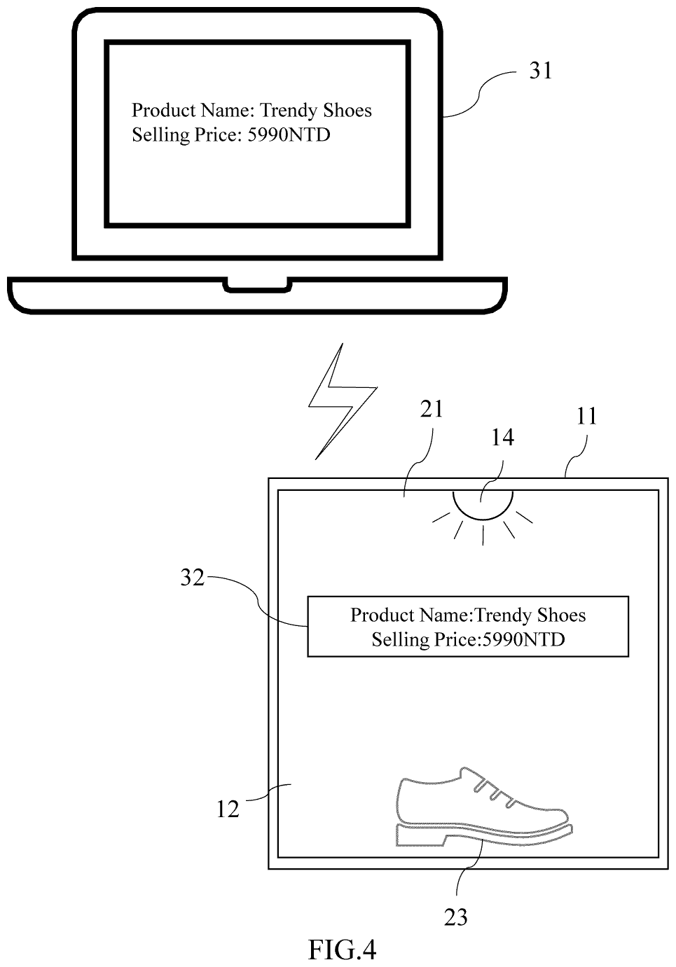

More specifically, referring to FIG. 4, a data signal of a displayed information that is about to be displayed on the display panel 12 could be transmitted to the display controller 13 through an external electronic device 31 in a wired way or in a wireless way, so that the display controller 13 outputs the data signal of animations, videos, images, or text for displaying on the display panel 12. When the light source 14 is turned on, the exhibit 23 and a displayed content 32 are presented together for the customers to view, thereby presenting the introduction of the exhibit 23 to the customers and drawing the attention of the customers. In the current embodiment, the external electronic device 31 is a computer as an example, but the external electronic device 31 could also be an electronic device that could transmit data, such as a smartphone, a smart watch, a tablet, a mobile hard drive, etc.

The light source 14 is disposed inside the body 11. The light source 14 is a single-color or multi-color LED light strip (or a light bulb), and is controllable to turn on and turn off. Additionally, the light transmittance of the display panel 12 in the direction from the first side 121 to the second side 122 is greater than the light transmittance of the display panel 12 in the direction from the second side 122 to the first side 121, so that when the light source 14 is turned on, a light from the light source 14 could penetrate from the first side 121 to the second side 122; on the other hand, when the light source 14 is turned off, an ambient light from an external environment could not penetrate from the second side 122 to the first side 121.

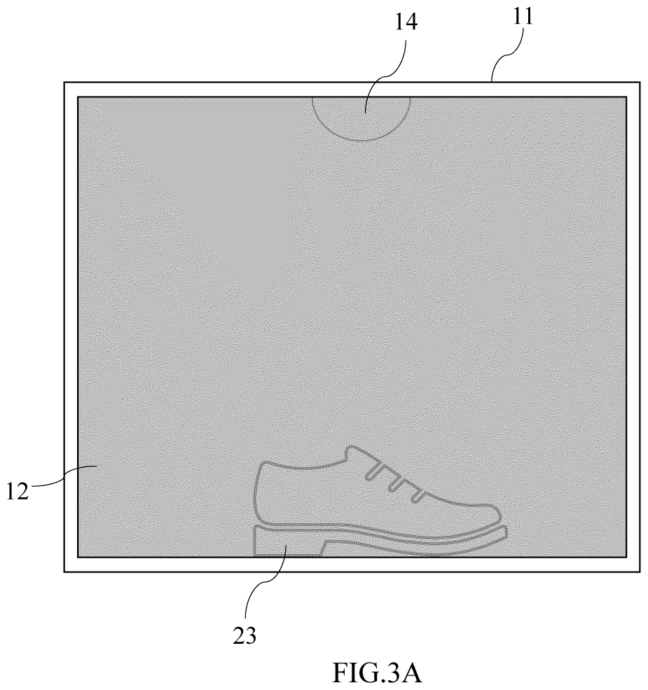

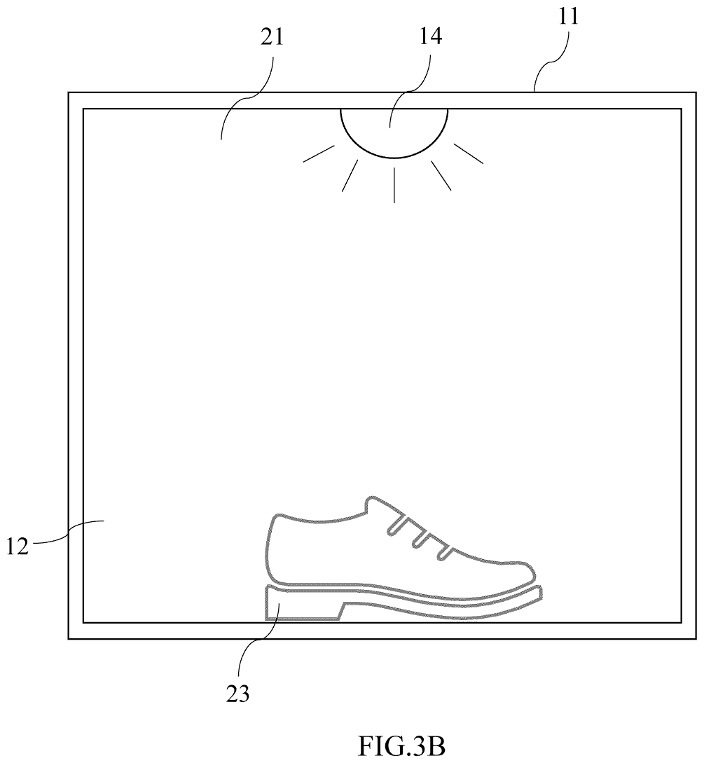

Thus, referring to FIG. 3A and FIG. 3B, when the light source 14 is turned on (as shown in FIG. 3B), the display panel 12 is in a transparent state due to the light emitted from the light source 14 passing through the display panel 12, so that a viewer could watch the displayed information displayed on the display panel 12 and the exhibit 23 disposed in the accommodation space 21 from an outside of the exhibition box 1; when the light source 14 is turned off, the display panel 12 is in a black state as the ambient light from the external environment could not pass through the display panel 12, so that the viewer could not watch the displayed information displayed on the display panel 12 and the exhibit 23 disposed in the body 11 from the outside of the exhibition box 1. In this way, by turning off the light source 14, the user could replace the exhibit 23 and synchronously replace the displayed content 32 without being noticed by the viewer. For example, when the user needs to replace the exhibit 23 during business hours, the user only needs to turn off the light source 14, replaces the exhibit 23, and directly modifies an introduction of the replaced exhibit 23 outputted to the display panel 12 instead of waiting for an end of the business hours or a break time to replace the exhibit 23 and decorate the exhibition box 1.

Furthermore, to enhance a visual experience of the viewer, the light source 14 could be disposed inside the body 11; the light source 14 could be located around the display panel 12 or disposed on at least one of a left wall surface, a right wall surface, a top wall surface, and the bottom surface of the inner portion of the body 11. In order to prevent the viewer from directly facing the light emitted from the light source 14 and causing harm and discomfort to the eyes of the viewer when the light source 14 is turned on, disposing the light source 14 on a side of the body 11 opposite of the display panel 12 (i.e. a back side surface of the inner portion of the body 11) should be avoided.

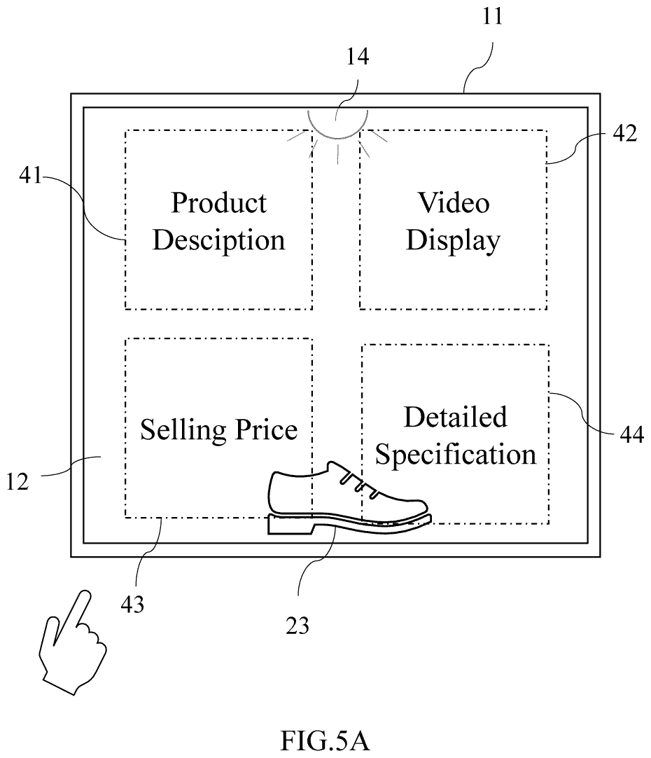

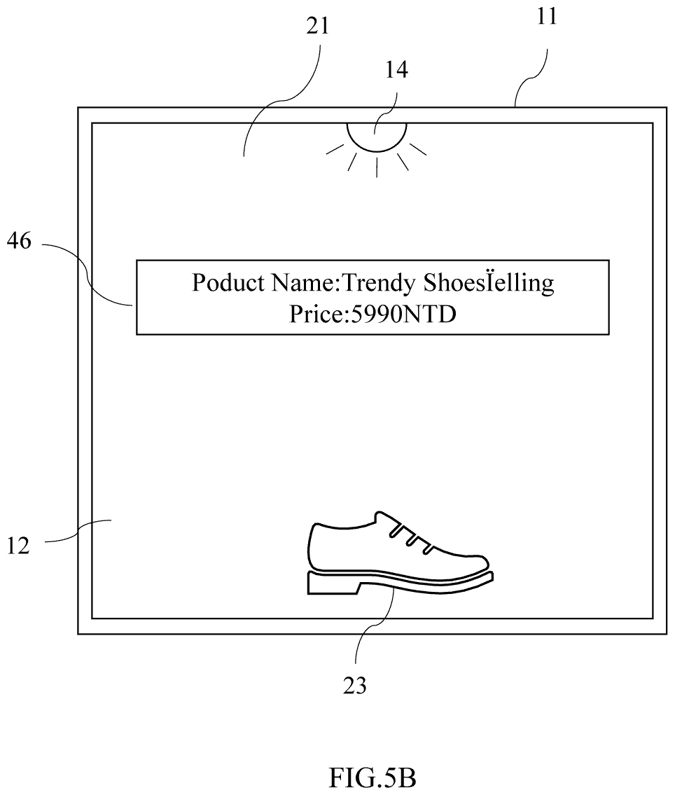

Additionally, referring to FIG. 5A and FIG. 5B, in a second embodiment, the display controller 13 displays a completed setting content as at least one function icon on the display panel 12. In the current embodiment, the at least one function icon includes a plurality of function icons 41˜44, but not limited thereto; the number of the function icon could be adjusted to meet different requirements. A touch sensor device is disposed on the display panel 12 and is adapted to sense a location of the display panel 12 where the user touches and to transmit a touch information, which corresponds to the location of the display panel touched by the user, to the display controller 13. Thus, after the viewer touches one of the function icons 41˜44 on the display panel 12, the touch sensor device transmits the touch information to the display controller 13, so that the display panel 12 further displays a displayed content 46 corresponding to the touch information (i.e., one of the function icons 41˜41 selected by the viewer), so that the exhibition box 1 could achieve an effect of interacting with the viewer. For example, the function icons 41˜44 could be a video introduction for the exhibit 23, a schematic view showing how the exhibit 23 is used, an introduction of the production process for the exhibit 23, a basic text introduction for the exhibit 23, etc.

By selecting the displayed content 46 on the exhibition box 1, the exhibit 23 is introduced to the customers through the display panel 12, so that the exhibition box 1 achieves an effect of attracting the customers to learn more about the exhibit 23

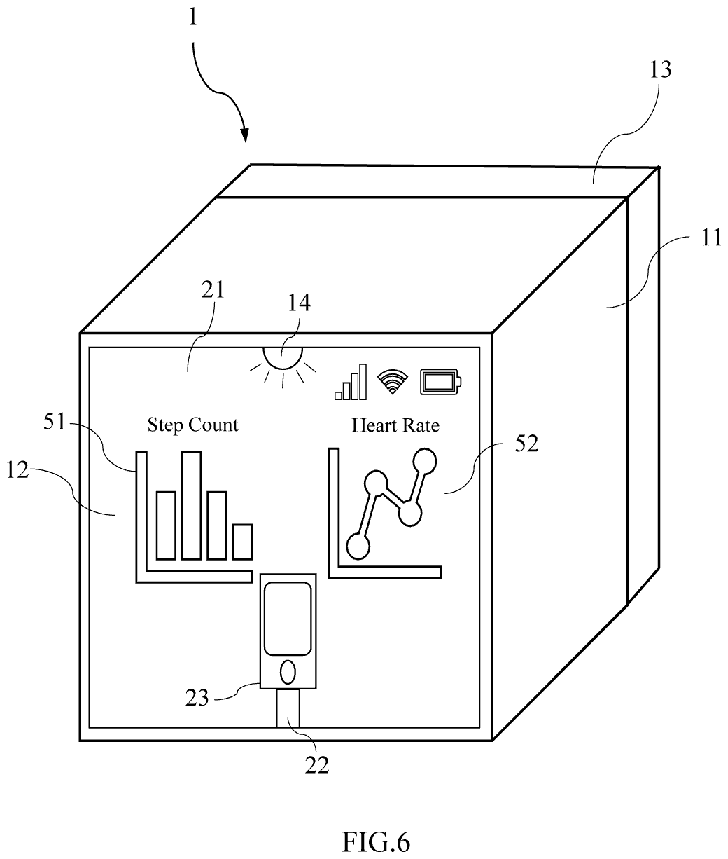

Additionally, referring to FIG. 6, in a third embodiment, the exhibit 23 is a smartphone and is disposed on the fixing device 22. After the fixing device 22 is connected to the exhibit 23 via signals, the fixing device 22 could selectively read an information stored in the exhibit 23 and output the information read to the display panel 12 through the display controller 13. For example, the exhibit 23 stores health information 51, 52 of the user; when the exhibit 23 is disposed on the fixing device 22, the fixing device 22 reads the health information 51, 52 on the exhibit 23 and transmits the health information 51, 52 to the display controller 13; then, the display controller 13 transmits the health information 51, 52 to the display panel 12. Thus, the health information 51, 52 could be presented to the user through images that are easily understandable and the exhibit 23 could be charged synchronously during displaying, thereby achieving multiple purposes of displaying, interaction, and charging. The exhibit 23 is not limited to the smartphone and could be a tablet, an e-book, a laptop, a smartwatch, smart glasses, and so on.

The animations, the videos, the images, or the text to be presented are stored or set in the display controller 13 in different ways and the appropriate content is outputted and displayed on the display panel 12, so that the exhibition box 1 could avoid the time-consuming and laborious production of decorations for different exhibits 23 and could avoid the trouble in discarding the decorations and finding another opportunity for reusing the decorations when the exhibit 23 is removed.

Furthermore, the light could penetrate from the first side 121 of the display panel 12 to the second side 122 and could not penetrate from the second side 122 of the display panel 12 to the first side 121 Thus, the exhibit 23 inside the exhibition box 1 could be instantly replaced at any time no matter whether the viewer is present.

It must be pointed out that the embodiments described above are only some preferred embodiments of the present invention. All equivalent structures which employ the concepts disclosed in this specification and the appended claims should fall within the scope of the present invention.

What is claimed is:

1. An exhibition box, comprising:
a body, wherein an inner portion of the body has an accommodation space for placing an exhibit; the body has a through hole communicating with the accommodation space;
a display panel disposed on the body and covering the through hole, wherein the display panel has a first side and a second side; the first side faces toward the accommodation space; the second side faces away from the accommodation space; a light transmittance of the display panel in a direction from the first side to the second side is greater than a light transmittance of the display panel in a direction from the second side to the first side;
a display controller electrically connected to the display panel and adapted to output an image information to the display panel for displaying;
a light source disposed inside the body, wherein the light source is controllable to turn on and turn off; when the light source is turned on, a light of the light source penetrates from the first side to the second side, so that a displayed information displayed on the display panel and the exhibit placed in the accommodation space are observable from an outside of the exhibition box; when the light source is turned off, an ambient light from an external environment is unable to penetrate from the second side to the first side, so that the displayed information displayed on the display panel and the exhibit disposed in the accommodation space are not observable from the outside of the exhibition box.

2. The exhibition box as claimed in claim 1, wherein the light source is disposed inside the body; the light source is located around the display panel or disposed on at least one of a left wall surface, a right wall surface, a top wall surface, and a bottom surface of the inner portion of the body.

3. The exhibition box as claimed in claim 1, wherein a fixing device is disposed inside the body and adapted to fix or connect the exhibit.

4. The exhibition box as claimed in claim 3, wherein the fixing device is disposed on a bottom surface of the inner portion of the body.

5. The exhibition box as claimed in claim 1, wherein a touch sensor device is disposed on the display panel; the touch sensor device is electrically connected to the display controller and adapted to sense a location of the display panel where a user touches and to transmit a touch information, which corresponds to the location of the display panel touched by the user, to the display controller.

6. The exhibition box as claimed in claim 3, wherein the fixing device is a signal connector; the fixing device is electrically connected to the display controller; the fixing device is adapted to fix the exhibit and connect the exhibit via signals; after the fixing device reads an information stored in the exhibit, the fixing device transmits the information of the exhibit read to the display controller.

7. The exhibition box as claimed in claim 1, when the light source is turned on, the display panel is in a transparent state due to the light emitted from the light source passing through the display panel; when the light source is turned off, the display panel is in a black state as the ambient light from the external environment of the body is unable to pass through the display panel.

8. The exhibition box as claimed in claim 1, further comprising an external electronic device connected to the display controller via signals, wherein a data signal of the image information is transmitted to the display controller by the external electronic device in a wired manner or in a wireless manner; after the display controller receives the data signal of the image information, the display controller outputs the image information received to display on the display panel.

9. The exhibition box as claimed in claim 3, wherein the fixing device is an electrical connector; the exhibit is an electronic device; the fixing device is adapted to transmit an electrical signal to the exhibit for charging while fixing the exhibit.
